(19) United States
(12) Patent Application Publication
(10) Pub. No.: US 2025/0015387 A1
(43) Pub. Date: Jan. 9, 2025

(54) BATTERY CELL HAVING AN INTERNAL COOLING ELEMENT AND A BATTERY MODULE COMPRISING THE SAME

(71) Applicant: Dr. Ing. h.c F. Porsche Aktiengesellschaft, Stuttgart (DE)

(72) Inventors: Tim Schmidt, Freiberg am Neckar (DE); Benjamin Passenberg, Rutesheim (DE); Markus Göhring, Nufringen (DE); Gorazd Balejik, Prague (CZ); Dominik Grass, Bietigheim-Bissingen (DE)

(73) Assignee: Dr. Ing. h.c. F. Porsche Aktiengesellschaft, Stuttgart (DE)

(21) Appl. No.: 18/762,729

(22) Filed: Jul. 3, 2024

(30) Foreign Application Priority Data
Jul. 6, 2023 (DE) 102023117884.9

(51) Int. Cl. H01M 10/654; B60L 50/64; B60L 58/26; H01M 10/613; H01M 10/625; H01M 10/647; H01M 10/656; H01M 50/211

(52) U.S. Cl. CPC H01M 10/654; B60L 50/64; B60L 58/26; H01M 10/613; H01M 10/625; H01M 10/647; H01M 10/656; H01M 50/211; H01M 2220/20

(57) ABSTRACT

A battery cell with an internal cooling element includes an interior in which electrochemically active components are arranged. The interior has an outer wall on each of at least two sides, which are connected to each other by an inner wall. The internal cooling element is arranged in the inner wall. Also described is a battery module with at least two of the battery cells.

### CROSS-REFERENCE TO RELATED APPLICATION

This application claims priority to German Patent Application No. 10 2023 117 884.9, filed Jul. 6, 2023, the content of such application being incorporated by reference herein in its entirety.

### FIELD OF THE INVENTION

The present invention relates to a battery cell with an internal cooling element. The invention also relates to a battery module comprising at least two battery cells according to aspects of the invention.

### BACKGROUND OF THE INVENTION

Battery cells must be cooled in order to achieve a good service life and performance. This is particularly the case with battery cells in traction batteries for electric vehicles, which must be able to absorb and, in particular, deliver high levels of power. A large contact surface between the battery cell to be cooled and the cooling medium and a low thermal resistance are important for good heat transfer. The thermal resistance increases with the distance and the number of insulating layers between the cooling medium and the source of heat generation. In battery cells, the cooling is realized outside the battery cell, so that there is a relatively large distance between the active part of the battery cell, in which the waste heat is generated, and a cooling plate, for example.

DE 102009034675 A1, which is incorporated by reference herein, discloses an electrochemical energy storage device with at least two electrical current arresters for the electrical connection of the electrochemical energy storage device within an application environment. The current arresters have a first region arranged inside the electrochemical energy storage device and a second region arranged outside the electrochemical energy storage device, wherein at least one of these electrical current arresters is designed in such a way that a liquid or gaseous heat transport medium can flow through it in the second region.

Publication EP 2659540 B1, which is incorporated by reference herein, discloses a battery comprising a battery case having at least one open end; a battery cover sealing the opening end; an electric core accommodated in the battery case and comprising at least one heat-conducting member, wherein the heat-conducting member has at least one end passing through the battery cover; and an electrolyte which is filled in a space formed by the battery case with the battery cover.

Publication EP 2659540 B1, which is incorporated by reference herein, discloses an electrical energy storage cell for a motor vehicle with a housing which defines an interior in which electrochemical components of the energy storage cell are accommodated, and with a line running through the interior, via which a cooling or heating medium can be conducted through the interior.

### SUMMARY OF THE INVENTION

Based on this, described herein is an efficient and at the same time cooling concept for a battery cell and a battery module based on it, which also entails as little additional weight as possible.

According to aspects of the invention, a battery cell with an internal cooling element is provided, having an interior in which electrochemically active components are arranged, wherein the interior has an outer wall on or on at least two sides, which are connected to one another by an inner wall. The battery also comprises the internal cooling element, which is arranged in the inner wall. The electrochemically active components can be the chemical substances and elements required for energy storage in batteries. In principle, the battery cell described herein can be of different types, for example a lithium-ion battery. In such a case, the electrochemically active components can, for example, comprise a graphite electrode (negative) and a lithium metal oxide electrode (positive), wherein the lithium metal oxide can comprise different proportions of nickel, manganese and cobalt. However, the present battery cell according to aspects of the invention is not dependent on a specific battery cell chemistry or type but can be used in combination with different battery cell chemistries.

In terms of design, the battery cell according to aspects of the invention described herein can correspond to a pouch cell. In principle, the battery cell according to aspects of the invention can be an accumulator cell or a battery cell of an accumulator or a battery, in particular a traction battery of an electric vehicle.

In the battery cell according to aspects of the invention, the cooling element, which may comprise at least one cooling plate, for example, is integrated directly into the battery cell, i.e. into its interior. A coolant can flow through the cooling element to cool the battery cell. This results in a very small distance between the electrochemically active components inside the battery cell and the cooling element, whereby a very good heat transfer from the electrochemically active components to the coolant can be achieved.

The at least two outer walls can, for example, be opposite outer walls, such as the end faces of an essentially cuboid battery cell, wherein at least some of the edges of the surrounding casing can be rounded.

The outer walls and the inner wall can be connected to each other in a structurally stable manner, i.e. form a mechanically stable framework around which, for example, an electrically insulating casing can be stretched or wrapped. In other words, the inner wall can be a load-bearing or supporting wall or structure that transmits forces acting on the at least one outer wall to the at least one further outer wall. The internal cooling element can thus have an additional stiffening effect on the battery cell and can protect the battery cell from deformation during the assembly of a corresponding battery module, during operation or in the event of damage. The internal cooling element can therefore be characterized by the fact that it is surrounded by the active material on at least two sides. If necessary, the internal cooling element can divide the interior within the battery cell into two compartments.

According to further embodiments of the battery cell according to aspects of the invention, the battery cell may further comprise a coolant inflow and a coolant outflow, which may be arranged on at least one outer side of the battery cell and are provided for forming a coolant flow through the cooling element. In principle, the coolant inlet and outlet can be arranged on one side of the cooling element or on an outer wall, or just as well on different outer walls.

According to further embodiments of the battery cell according to aspects of the invention, the inner wall can be arranged centrally inside the battery cell. The inner wall can have a meandering or zigzag shape in order to increase the contact surface between the inner wall and the chemically active components compared to a plate-like embodiment in which the inner wall has essentially flat surfaces.

According to further embodiments of the battery cell according to aspects of the invention, the at least two outer walls and the inner wall connecting them can form an H-shaped structure.

According to further embodiments of the battery cell according to aspects of the invention, the electrochemically active components may comprise an active material.

According to further embodiments of the battery cell according to aspects of the invention, the inner wall can be arranged in a neutral fiber of the active material.

According to further embodiments of the battery cell according to aspects of the invention, this can be encased in an electrically insulating material, which represents a casing of the battery cell and can be understood as a “soft” housing (in comparison to the “stiff” housing of conventional battery cells). The outer walls, which are firmly connected to each other by means of the inner wall, act as a clamping structure for the insulating material, for example a film, which can also serve to protect the battery cell.

According to aspects of the invention, a battery module is also provided, which comprises at least two battery cells as described above, which are connected to one another in series or in parallel.

In one embodiment, the battery cell according to aspects of the invention can correspond to a pouch cell turned “inside out”. Until now, a stiff housing has been built around the active material in conventional pouch cells and then a cooling plate or cooling structure is attached to the outside of the battery cell. In the present invention, a part of the structural housing, e.g. two opposing outer walls, is placed inwardly, preferably centrally between the active material. In addition, the cooling structure is integrated or laid in this inner wall, which can then be located in the neutral fiber of the active material, for example. The cooling structure is used to dissipate heat to the outside—for example, a cooling medium can flow through it during operation. The cooling/heat dissipation then advantageously takes place over the entire surface of the core of the active material, for example along the center plane of the active material volume.

It is understood that the aforementioned features and the features yet to be explained in the following can be used not only in the respectively specified combination, but also in other combinations, or on their own, without leaving the scope of the present invention.

### BRIEF DESCRIPTION OF THE DRAWINGS

Additional advantages and configurations of the invention emerge from the description and the enclosed drawings.

FIG. 1 shows a schematic sectional view of an ordinary battery cell.

FIG. 2 shows a schematic sectional view of an example embodiment of the battery cell according to aspects of the invention.

FIG. 3 shows a perspective view of an example embodiment of the battery cell according to aspects of the invention.

### DETAILED DESCRIPTION OF THE INVENTION

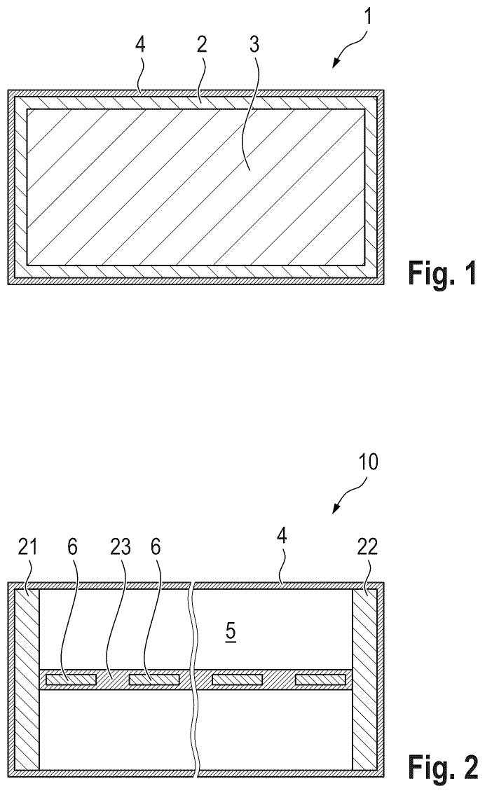

FIG. 1 shows a schematic sectional view of an ordinary battery cell 1. This has a usually stiff or stiffening housing 2 in which the active material 3 is arranged. To protect the battery cell 1, it is tightly encased with an electrically insulating material 4. For cooling purposes, a cooling plate or cooling structure is attached to the battery cell 1 from the outside (not explicitly shown in FIG. 1).

FIG. 2 shows a schematic sectional view of an example embodiment of the battery cell 10 according to aspects of the invention. In contrast to the conventional battery cell 1 shown in FIG. 1, there is no surrounding stable housing 2 here. The example embodiment of the battery cell 10 shown in FIG. 2 has an interior 5 in which electrochemically active components are arranged, wherein the interior 5 has an outer wall on each of at least two sides, in the example embodiment shown a first outer wall 21 and a second outer wall 22, which are connected to one another by an inner wall 23.

Furthermore, the battery cell 10 has an internal cooling element 6, which is arranged in the inner wall 23. In the example embodiment shown, the cooling element 6 is in the form of cooling ducts running through the inner wall, wherein the direction of the cooling ducts 6 is perpendicular to the plane of the sheet.

The number and shape of the cooling ducts forming the cooling element 6 can be adapted as required. The course of the cooling ducts in the inner wall, for example whether each cooling duct extends between an inlet and outlet or has several 180° deflections between inlet and outlet, is also a question of the design of the cooling concept and can be adapted as required. For example, only one cooling duct can be provided in the inner wall 23. Regardless of the exact structure of the cooling element 6, the outer walls of the cooling element 6 also form the inner wall 23 running through the interior 5.

As in the case of the conventional battery cell 1 shown in FIG. 1, the battery cell 10 according to aspects of the invention is also tightly encased with an electrically insulating material 4. In other embodiments, the electrically insulating material 4 can only be wound along the casing of the battery cell 10 so that the end faces are exposed, for example. The end faces can be made of a material that is eclectically insulating. It should also be noted that the connection electrodes of the battery cell 10 are not explicitly shown, as they play a subordinate role from the point of view of the invention.

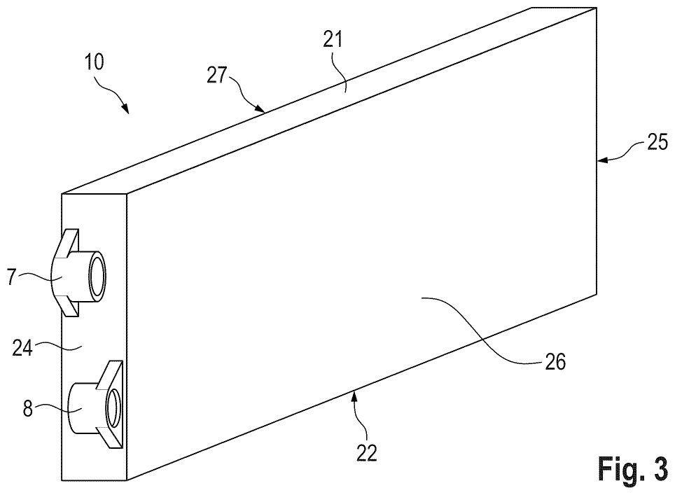

FIG. 3 shows a perspective view of an example embodiment of the battery cell 10. The outer casing of the battery cell 10 is formed by the first outer wall 21 and the second outer wall 22 opposite it. In this example embodiment, the outer casing of the battery cell 10 is also formed by a third outer wall 24, a fourth outer wall 25, a fifth outer wall 26 and a sixth outer wall 27, each of which is arranged in pairs opposite one another. The six outer walls 21-27 are all connected to each other and form a box-shaped casing for the battery cell. The inner wall is arranged inside the battery cell 10 so that a cooling medium can flow into the cooling element 6 via the inlet 7, flow through the cooling element inside the battery cell 10 and then flow out of the cooling element through the outlet 8. In a modified example embodiment of the battery cell 10, the coolant inlet 7 and the coolant outlet 8 can be arranged on different, in particular opposite, outer walls of the battery cell 10. For example, the coolant inlet 7 or the coolant outlet in FIG. 3 can just as well be arranged on the fourth outer wall 25.

What is claimed is:

1. A battery cell comprising:
electrochemically active components;
side walls connected to one another by an inner wall, said side walls at least partially defining an interior in which the electrochemically active components are arranged; and
an internal cooling element arranged in the inner wall.

2. The battery cell according to claim 1, further comprising: a coolant inflow and a coolant outflow, each which of are arranged on at least one outer side of the battery cell and form at least a portion of a coolant passageway through the cooling element.

3. The battery cell according to claim 1, wherein the inner wall is centrally arranged within the interior.

4. The battery cell according to claim 1, wherein the at least two side walls and the inner wall form an H-shaped structure.

5. The battery cell according to claim 1, wherein the electrochemically active components comprise an active material.

6. The battery cell according to claim 5, wherein the inner wall is arranged in a neutral fiber of the active material.

7. The battery cell according to claim 1, wherein the battery cell is encased in an electrically insulating material.

8. A battery module comprising at least two of the battery cells according to claim 1, which battery cells are connected to one another either in series or in parallel.

9. A motor vehicle comprising the battery module of claim 8.
